(19) United States
(12) Patent Application Publication
(10) Pub. No.: US 2016/0253837 A1
(43) Pub. Date: Sep. 1, 2016

(54) PARALLAX BOUNCE

(71) Applicant: Lytro, Inc., Mountain View, CA (US)

(72) Inventors: Yin Zhu, San Jose, CA (US); Tony Poon, Fremont, CA (US); Yi-Ren Ng, Palo Alto, CA (US)

(21) Appl. No.: 14/632,956

(22) Filed: Feb. 26, 2015

(51) Int. Cl. G06T 15/20; G06F 3/0485; G06F 3/0484

(52) U.S. Cl. CPC G06T 15/205; G06F 3/04847; G06F 3/0485

(57) ABSTRACT

As a moving or sliding image reaches, or is about to reach, a target location where its motion slows or stops, a parallax shift is applied. The effect, referred to as a parallax bounce, can be applied in any context wherein an image is moved from one location to another on a display screen, such as for example a sliding or scrolling operation. The parallax bounce can be applied, for example, when the image stops moving, or is about to stop moving. Different objects of different depths in the image shift to different degrees, an effect that is accomplished by laterally shifting the apparent viewpoint of the image. The magnitude of the parallax shift increases progressively, stops, and then decreases to zero, in a manner that simulates a bounce effect.

### CROSS-REFERENCE TO RELATED APPLICATIONS

The present application is related to U.S. Utility application Ser. No. 11/948,901 for “Interactive Refocusing of Electronic Images,” (Atty. Docket No. LYT3000), filed Nov. 30, 2007, which issued on Oct. 15, 2013 as U.S. Pat. No. 8,559,705, the disclosure of which is incorporated herein by reference.

The present application is further related to U.S. Utility application Ser. No. 12/632,979 for “Light-field Data Acquisition Devices, and Methods of Using and Manufacturing Same,” (Atty. Docket No. LYT3002), filed Dec. 8, 2009, which issued on Oct. 16, 2012 as U.S. Pat. No. 8,289,440, the disclosure of which is incorporated herein by reference.

The present application is further related to U.S. Utility application Ser. No. 13/669,800 for “Parallax and/or Three-Dimensional Effects for Thumbnail Image Displays,” (Atty. Docket No. LYT089), filed Nov. 6, 2012, the disclosure of which is incorporated herein by reference.

### FIELD

The present disclosure relates to electronic devices that display images on a display screen.

### DESCRIPTION OF THE RELATED ART

Many electronic devices are capable of displaying digital images, either in two or three dimensions. In many contexts, users may scroll through a plurality of images by performing some gesture or command. For example, in an app for viewing a sequence of images, a user may swipe left on a touch-sensitive screen to dismiss an image and cause the next image in the sequence to be displayed; similarly, swiping right causes the current image to be dismissed and replaced by the previous image in the sequence. It is common, in such an app, for the image to be dismissed by sliding off an edge of the screen (in the direction of the swipe), and for the newly introduced image to slide in from the opposite edge of the screen.

FIG. 1 depicts an example of such an operation, as is known in the art. In screen shot 100A, image 101A is displayed on display screen 102. The user performs a swipe gesture in a leftward direction, to cause image 101A to slide off the left edge of the screen. As shown in screen shot 100B, as image 101A slides off the left edge of the screen, the next image in the sequence (image 101B), slides into view from the right edge of the screen. Once the image 101E reaches a central position on the screen, its leftward motion stops. Screen shot 100C depicts the screen after the swipe operation is complete; image 101A has been dismissed, and image 101B is now displayed on display screen 102.

### SUMMARY

According to various embodiments, as a moving or sliding image reaches, or is about to reach, a target location where its motion slows or stops, a parallax shift is applied to the image. A measure of momentum is applied to the parallax shift, so as to resemble a bounce effect. The effect, referred to as a parallax bounce, can be applied in any context wherein an image is moved from one location to another on a display screen, such as for example a sliding or scrolling operation. The parallax bounce can be applied at the beginning and/or end of the image's movement, and/or at any time when the movement of the image changes velocity.

In at least one embodiment, the parallax bounce is applied when the image stops moving, or is about to stop moving. The parallax bounce has the effect of causing at least some portions of the image to appear to continue moving for some period of time after the overall image has stopped moving. In at least one embodiment, depth information for different portions of the image is used as a control parameter for adjusting the degree to which the parallax shift is applied. Depth information indicates an apparent distance between an object in the image and the camera position; objects that are farther away are said to have greater depth. Depth values can also be negative, meaning that an object is appearing to pop out of the screen. Depth information can be available, for example, if the image is a light-field image, although the techniques described herein can be applied to other images than light-field images. Thus, in at least one embodiment, objects that are at greater depth move more, while objects that are at lesser depth (i.e. closer to the camera position) move less or not at all. This variable degree of shift, depending on object depth, is accomplished by laterally shifting the apparent viewpoint of the image, so as to cause a parallax shift.

The magnitude of the parallax shift increases progressively, stops, and then decreases to zero, in a manner that simulates a bounce effect, or rubber band effect. In at least one embodiment, the parallax shift can even continue in the opposite direction, then stop and decrease to zero. Any number of iterations can be performed, with each repetition of the dynamic parallax shift being of lower total magnitude, bouncing back and forth until the image finally reaches a resting position with no parallax shift.

In at least one embodiment, the final display includes no parallax shift. In at least one embodiment, a final fixed parallax shift can remain after the bounce effect is complete. Other embodiments are possible, including those in which the bounce effect is combined with parallax shift that can take place in response to user movement or tilting of the device, or cursor movement, as described for example in the above-referenced related application.

The parallax bounce effect can be applied to 2D or 3D images of any suitable type. It can also be applied to non-image content, such as text or other content. In at least one embodiment, the magnitude of the total effect can be adjusted, either by the user or by an application author, or by an administrator.

Further details and variations are described herein.

### BRIEF DESCRIPTION OF THE DRAWINGS

The accompanying drawings illustrate several embodiments. Together with the description, they serve to explain the principles of the system and method according to the embodiments. One skilled in the art will recognize that the particular embodiments illustrated in the drawings are merely exemplary, and are not intended to limit scope.

FIG. 1 is a series of screen shots depicting an example of an operation for moving from one image to the next image in a sequence of images, according to the prior art.

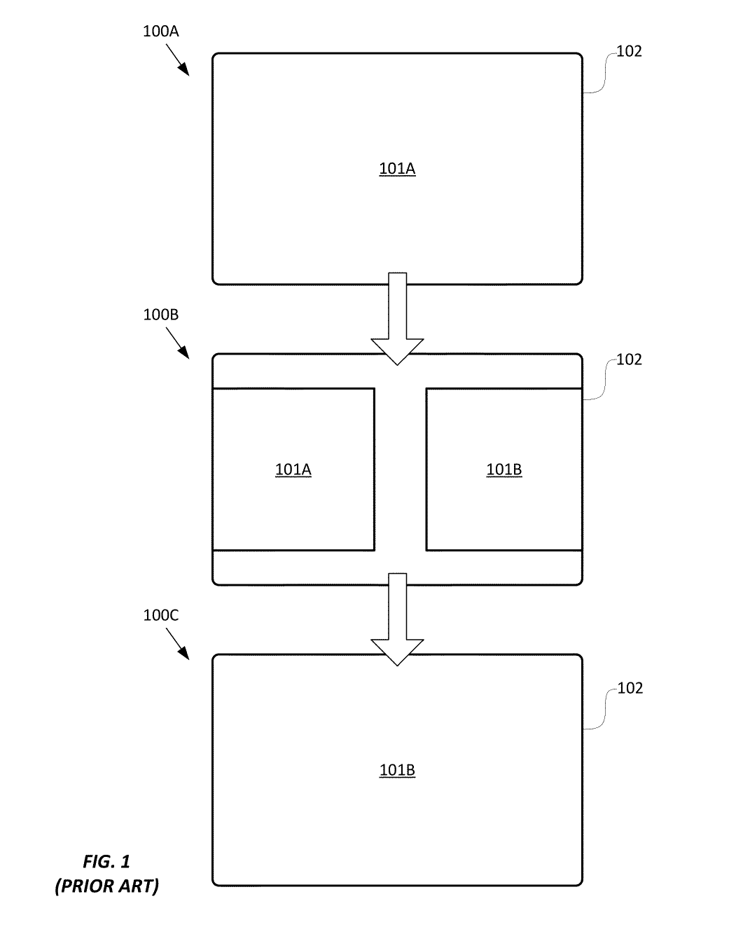

FIG. 2A is a block diagram depicting a hardware architecture for applying a parallax bounce effect to an image displayed on an electronic device according to one embodiment.

FIG. 2B is a block diagram depicting a client/server hardware architecture for applying a parallax bounce effect to an image displayed on an electronic device according to one embodiment.

FIG. 3 is a flow diagram depicting a method for applying a parallax bounce effect to an image displayed on an electronic device, according to one embodiment.

FIG. 4 is an example illustrating application of a parallax bounce effect to an image displayed on an electronic device, according to one embodiment.

FIG. 5 is another example illustrating application of a parallax bounce effect to an image displayed on an electronic device, according to one embodiment.

FIGS. 6A through 6D are graphs illustrating examples of timing curves for application of a parallax bounce effect to an image displayed on an electronic device.

### DETAILED DESCRIPTION OF THE EMBODIMENTS

### Terminology

The following terms are defined for purposes of the description provided herein:
Light-field: a collection of rays. A ray's direction specifies a path taken by light, and its color specifies the radiance of light following that path.
Light-field image: a two-dimensional image that spatially encodes a four-dimensional light-field.
Device: any electronic device capable of capturing, acquiring, processing, transmitting, receiving, and/or displaying pictures and/or image data.
Rendered image (or projected image): any image that has been generated from depth-enhanced image data (such as a light-field image), for example by rendering the depth-enhanced image data at a particular depth, viewpoint, and/or focal distance.
User, end user, viewer, end viewer: These are terms that are used interchangeably to refer to the individual or entity to whom a rendered image is presented.
Parallax shift: Refers to the phenomenon by which an apparent viewpoint for an image can change, thus simulating an actual change in appearance that might appear in response to a change in viewing angle. For purposes of the description herein, “parallax shift” is equivalent to “viewpoint change”.
Parallax bounce: A parallax shift that progressively increases in magnitude, reaches a maximum, and then progressively decreases in magnitude.
Lambda (depth): A measure of depth within a scene. For example, a zero-parallax lambda represents a value of lambda indicating distance (depth) with respect to the plane of the screen on which the image is being displayed.

According to various embodiments, the system and method described herein can be implemented on any electronic device equipped to display images. The images can be captured, generated, and/or stored at the device, though they need not be. Such an electronic device may be, for example, a standalone digital camera, smartphone, desktop computer, laptop computer, tablet computer, kiosk, game system, television, or the like. The displayed images can be still photos, video, computer-generated images, artwork, or any combination thereof.

Although the system is described herein in connection with an implementation in a digital camera, one skilled in the art will recognize that the techniques described herein can be implemented in other contexts, and indeed in any suitable device capable of displaying images. Accordingly, the following description is intended to illustrate various embodiments by way of example, rather than to limit scope.

In at least one embodiment, the system and method described herein can be implemented in connection with light-field images captured by light-field capture devices including but not limited to those described in Ng et al., Light-field photography with a hand-held plenoptic capture device, Technical Report CSTR 2005-02, Stanford Computer Science.

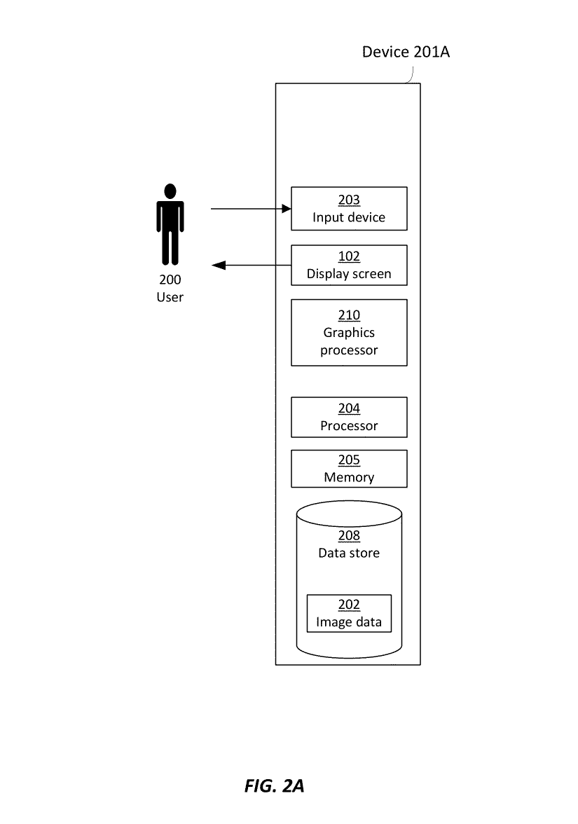

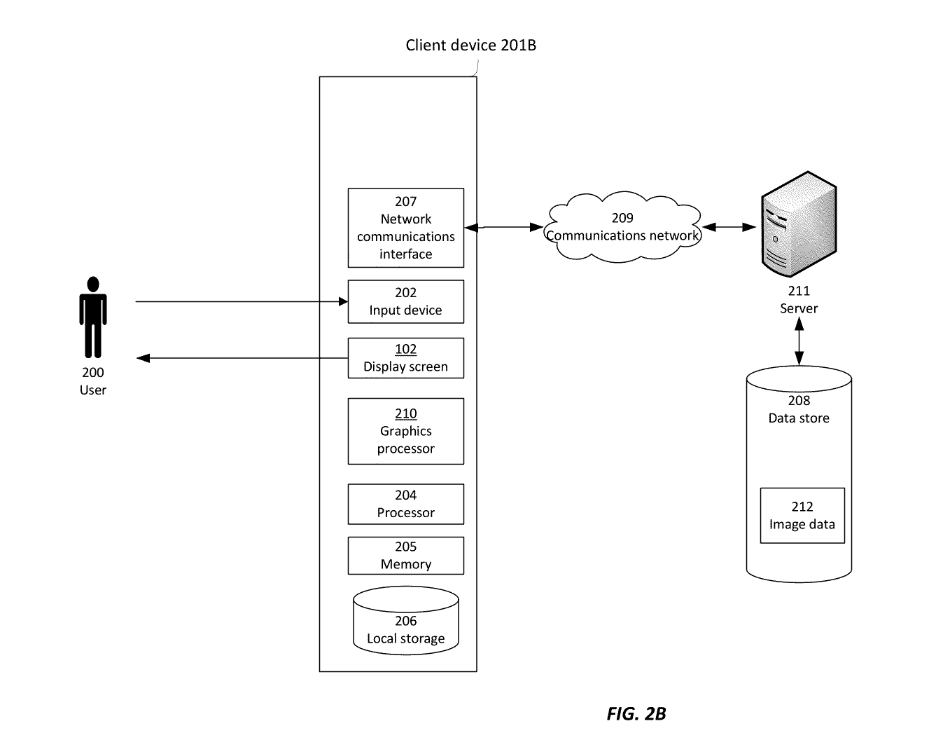

Referring now to FIG. 2A, there is shown a block diagram depicting a hardware architecture for applying a parallax bounce effect to an image displayed on an electronic device, according to one embodiment. Such an architecture can be used, for example, for implementing the techniques described herein in a digital camera, or other device 201. Device 201 may be any electronic device equipped to display images.

In one embodiment, device 201 has a number of hardware components well known to those skilled in the art. Display screen 102 can be any element that displays images. Input device 203 can be any element that receives input from user 200. In one embodiment, display screen 102 and input device 203 are implemented as a touch-sensitive screen, referred to as a “touchscreen,” which responds to user input in the form of physical contact. For example, images can move on display screen 102 in response to user 200 performing a gesture on the touchscreen, such as sliding his or her finger along the surface of the touchscreen.

Alternatively, display screen 102 can be any output mechanism that displays images, and input device 203 can be any component that receives user input. For example, input device 203 can be implemented as a separate component from display screen 102, for example a keyboard, mouse, dial, wheel, button, trackball, stylus, or the like, dedicated to receiving user input. Input device 203 can also receive speech input or any other form of input, to cause images to move on display screen 102. Reference herein to a touchscreen is not intended to limit the system and method to an embodiment wherein the input and display functions are combined into a single component.

Processor 204 can be a conventional microprocessor for performing operations on data under the direction of software, according to well-known techniques. Memory 205 can be random-access memory, having a structure and architecture as are known in the art, for use by processor 204 in the course of running software. In at least one embodiment, a graphics processor 210 can be included to perform the parallax bounce effect described herein, and/or other graphics rendering operations.

Data store 208 can be any magnetic, optical, or electronic storage device for data in digital form; examples include flash memory, magnetic hard drive, CD-ROM, or the like. In one embodiment, data store 208 stores image data 202, which can be stored in any known image storage format, such as for example JPG. Data store 208 can be local or remote with respect to the other components of device 201.

Data store 208 can be local or remote with respect to the other components of device 201. In at least one embodiment, device 201 is configured to retrieve data from a remote data storage device when needed. Such communication between device 201 and other components can take place wirelessly, by Ethernet connection, via a computing network such as the Internet, via a cellular network, or by any other appropriate means. This communication with other electronic devices is provided as an example and is not necessary.

Image data 202 can be organized within data store 106 so that images can be presented linearly in a list. Data store 208, however, can have any structure. Accordingly, the particular organization of image data 202 within data store 208 need not resemble the list form as it is displayed on display screen 102. Image data 202 can include representations of 2D images, 3D images, and or light-field images. Light-field images can be captured and represented using any suitable techniques as described in the above-referenced related applications.

In at least one embodiment, device 201 can include an image capture apparatus (not shown), used by device 201 to capture external images, although such apparatus is not necessary. In one embodiment, such image capture apparatus can include a lens that focuses light representing an image onto a photosensitive surface connected to processor 204, or any other mechanism suitable for capturing images. In one embodiment, such image capture apparatus can include a microlens assembly that facilitates capture of light-field image data, as described for example in Ng et al.

In one embodiment, display screen 102 includes a mode in which one image is featured at a time. For example, the featured image may (but need not) occupy most of display screen 102, and user input from input device 203 may be interpreted as commands that cause (among other actions):
(1) the featured image to change to the immediately subsequent image in the list; or
(2) the featured image to change to the immediately preceding image in the list.

In at least one embodiment, such changes from one image to another image are performed by causing an image to appear to slide off one edge of display screen 102, while causing another image to appear to slide onto display screen 102 from the opposite edge. Such sliding can be performed in response to user input, such as a swipe gesture. Alternatively, such sliding can be performed automatically without any user input, for example, when playing a slide show wherein a new image is shown every few seconds.

Referring now to FIG. 2B, there is shown a block diagram depicting a hardware architecture in a client/server environment, according to one embodiment. Such an implementation may use a “black box” approach, whereby data storage and processing are done completely independently from user input/output. An example of such a client/server environment is an Internet-based implementation, wherein client device 201 runs a browser or app that provides a user interface for interacting with web pages and/or other Internet-based content from server 211. Images based on image data 212 from data store 208 associated with server 211 can be presented as part of such web pages and/or other Internet-based content, using known protocols and languages such as Hypertext Markup Language (HTML), Java, JavaScript, and the like.

Client device 201 can be any electronic device incorporating the input device 202 and/or display screen 102, such as a desktop computer, laptop computer, personal digital assistant (PDA), cellular telephone, smartphone, music player, handheld computer, tablet computer, kiosk, game system, or the like. Any suitable type of communications network 209, such as the Internet, can be used as the mechanism for transmitting data between client device 201 and server 211, according to any suitable protocols and techniques. In addition to the Internet, other examples include cellular telephone networks, EDGE, 3G, 4G, long term evolution (LTE), Session Initiation Protocol (SIP), Short Message Peer-toPeer protocol (SMPP), SS7, Wi-Fi, Bluetooth, ZigBee, Hypertext Transfer Protocol (HTTP), Secure Hypertext Transfer Protocol (SHTTP), Transmission Control Protocol/Internet Protocol (TCP/IP), and/or the like, and/or any combination thereof. In at least one embodiment, client device 201 includes a network communications interface 207 for enabling communication with server 211 via network 209.

In at least one embodiment, client device 201 transmits requests for data via communications network 209, and receives responses from server 211 containing the requested data. Data from server 211, including image data 212, is transmitted via network 209 to client device 201. Local storage 206 at client device 201 can be used for storage of image data 212.

In this implementation, server 211 is responsible for data storage and processing, and incorporates data store 208 for storing image data 212. Server 211 may include additional components as needed for retrieving image data 212 from data store 208 in response to requests from client device 201.

In at least one embodiment, data store 208 may be organized into one or more well-ordered data sets, with one or more data entries in each set. Data store 208, however, can have any suitable structure. Accordingly, the particular organization of data store 208 need not resemble the form in which image data 212 from data store 208 is displayed to user 200.

Thus, the techniques described herein can be applied to any image(s) being displayed on device 201A or client device 201B, whether such image(s) were captured at device 201A or 201B, or captured elsewhere and then transmitted to or accessed by device 201A or 201B.

In one embodiment, the system can be implemented as software written in any suitable computer programming language, whether in a standalone or client/server architecture. Alternatively, it may be implemented and/or embedded in hardware.

### Method

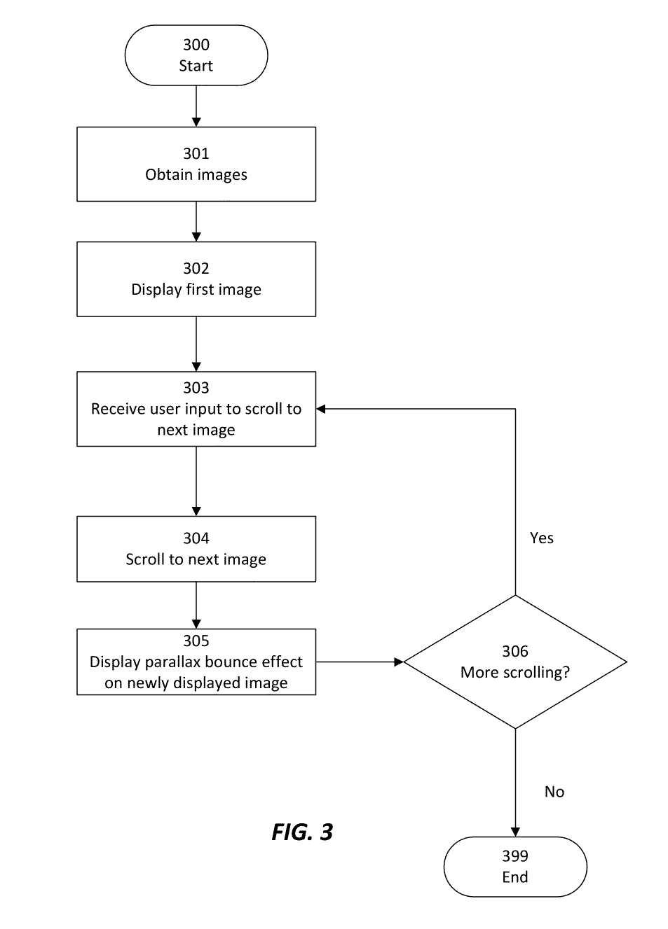

Referring now to FIG. 3, there is shown a flow diagram depicting a method for applying a parallax bounce effect to an image displayed on an electronic device, according to one embodiment. The method depicted in FIG. 3 can be implemented using any device for displaying images, such as for example device 201A and/or client device 201B, collectively referred to as device 201. Device 201 obtains 301 images (for example by retrieving image data 202), from server-based or client-based data store 208 or local storage 206, or from some other source. In at least one embodiment, a number of images can be obtained before any images are displayed, so as to speed up response time. Alternatively, images can be obtained as they are needed for display. In at least one embodiment, the images form a linear sequence of images, although such sequence is not necessary, and images can be displayed in any order. Image data 202 for images can be 2D, 3D or light-field data, or any other type of image data, stored in any suitable compressed or non-compressed format.

A first image is displayed 302 on display screen 102. In at least one embodiment, displaying 302 an image includes displaying a conventional 2D or 3D images. Alternatively, if image data 202 constitutes light-field data, displaying 302 an image can include projecting of the light-field data to generate a 2D or 3D image for display. This generated image is referred to as a rendered image.

In step 303, input device 203 receives user input to cause a different image to be displayed. Such input can include, for example a scroll command. One example of such a command is a swipe gesture provided via a touch-sensitive screen, although any other type of suitable input can be provided. In at least one embodiment, the method can be performed without receiving user input; for example, the context of a slide show presentation, the system can be configured to periodically display a new image without any direct prompting or input from the user. The parallax bounce techniques described herein can be implemented in any context where an image is moved on display screen 102, regardless of the particular mechanism by which the movement of image was triggered.

In response to the user input of step 303 (or any other trigger event causing a new image to be displayed), display screen 102 scrolls 304 to the next image. Any image can be considered the “next” image, and the depicted method is not limited to applications where a linear sequence is pre-established. Accordingly, the step 304 of scrolling to the next image can include any step by which a new image is displayed on display screen 102.

In at least one embodiment, introduction of the new image in step 304 involved sliding the image in from the edge of display screen 102. When the sliding process has completed, or nearly completed, and the new image is at (or close to) its featured display location, a parallax bounce effect is displayed 305. As described in more detail below, the parallax bounce effect involves dynamically and temporarily shifting the apparent viewpoint for the newly-displayed image in manner that gives the impression that the image has overshot its intended final location, as then returns to such location. In at least one embodiment, objects that are farther from the viewer (i.e., having greater lambda, or depth), are shifted more than objects that are closer to the viewer, giving a sensation of depth to the image.

In at least one embodiment, such parallax shift is implemented by dynamically projecting light-field image data at different viewpoints to generate different 2D projections of the light-field image data. More particularly, the viewpoint is progressively shifted linearly along the axis of movement of the image (such as horizontally, if the image is moved horizontally), and projections of the light-field data are generated as the shift occurs. In at least one embodiment, the shift is continuous and transient, bouncing back to the original location after a short period of time. In at least one embodiment, more than one bounce effect can be applied, with the viewpoint appearing to shift back and forth two or more times, in alternating directions; typically, each such iteration is of lesser maximum magnitude, so as to simulate a decay function that eventually subsides as the image comes to rest.

If more scrolling input is detected 306 (or if any other trigger events take place that indicate that a new image should be displayed), the method returns to step 303. Otherwise, the method ends 399.

### Parallax Bounce

In at least one embodiment, parallax bounce is applied in a manner that simulates a degree of inertia for the image that is sliding into place. In other words, parallax bounce is applied so as to appear as though the image overshoots its position as it stops its motion, or that the viewpoint of the user overshoots its position. In at least one embodiment, the magnitude of parallax bounce depends at least in part on the average speed with which the image slides into place, expressed for example in terms of pixels per second.

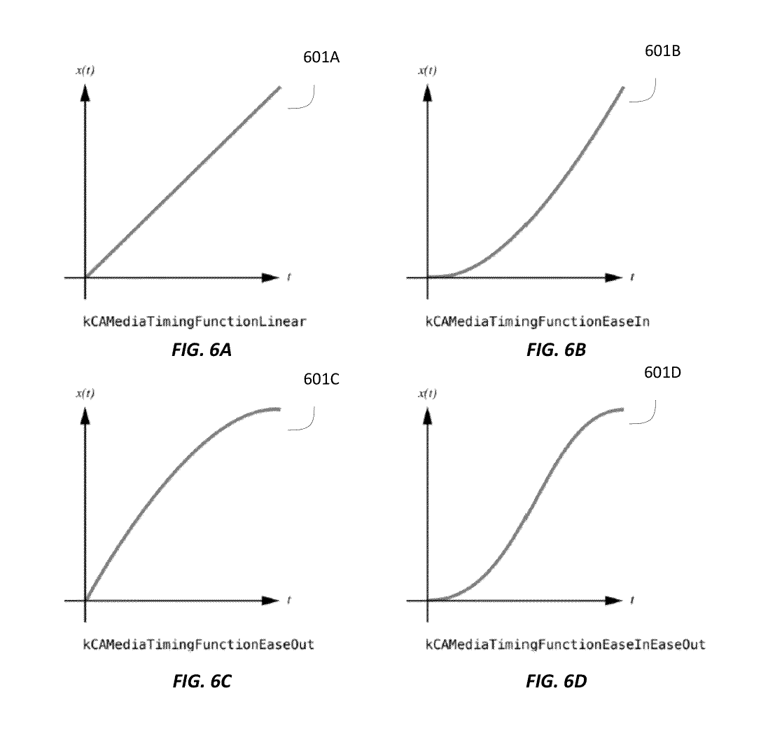

In at least one embodiment, the image sliding speed is nonlinear. Initially, the image moves quickly, but it then rapidly decelerates until it stops at the final target location. The speed pattern can follow, for example, a timing curve such as a parabolic “ease out” curve. Referring now to FIGS. 6A through 6D, there are shown examples of different types of timing curves 601A to 601D, which can be used to control the image sliding speed. For any of these curves, the average sliding speed (to determine magnitude of parallax bounce) can be calculated by taking the derivative of the curve.

In at least one embodiment, the image slides into place in response to a swipe gesture. In many devices and applications, the speed with which an image slides into place is dependent on the speed with which the user inputs the swipe gesture. Alternatively, the initial image sliding speed can be fixed, or can depend on any other factor or factors.

For example, in at least one embodiment, the initial image sliding speed is determined by how far the image needs to scroll to reach its target location, with a maximum distance limited to the width of the screen adjusted by the timing curve with a time duration of 0.25 seconds.

As described above, in at least one embodiment, the parallax bounce is initiated when the image has nearly slid into place at its target location. For example, it may be initiated when the image is 90% of the way to its target location. Alternatively, the parallax bounce can be initiated when the image has reached its target location and stopped moving.

In at least one embodiment, the magnitude of the parallax bounce (M), expressed in terms of picture width or height percentage, is determined by the average image sliding speed in pixels per seconds (S), multiplied by 1.25, divided by (10*view size), as follows:

M=(S*1.25)/(10*view size) (Eq. 1)

In at least one embodiment, M can be clipped to some maximum value, such as 0.3, to prevent excessive bounce which may introduce visual artifacts as the view perspective starts to go past the visible bounds of the image.

In at least one embodiment, the parallax bounce occurs in two parts. The first part, referred to as “bounce-out”, takes place in the same direction as that of the image slide. The second part, referred to as “bounce-back”, takes place in the opposite direction.

In at least one embodiment, the bounce-out is implemented as a perspective shift that starts at 0 and ends at M over some defined period of time, using any suitable timing curve. For example, the time period may be 0.375 seconds, and the timing curve may be one such as kCAMediaTimingFunctionEaseInEaseOut curve 601D depicted in FIG. 6D.

Subsequent to completion of the bounce-out, the bounce-in is performed. In at least one embodiment, the bounce-in is implemented as a perspective shift that starts at M and ends at 0 over some defined period of time, using any suitable timing curve. The time period and curve may be the same as that used for the bounce-out, or they may be different. In at least one embodiment, for example, the time period may again be 0.375 seconds, and the timing curve may again be one such as kCAMediaTimingFunctionEaseInEaseOut curve 601D depicted in FIG. 6D. In this example, then, the mirrored bounces create a smooth bell curve over a total of 0.75 seconds.

According to various embodiments, any suitable mechanism can be used for generating parallax bounce. Such mechanism may involve, for example, projecting light-field image data from progressively different viewpoints. Thus, one implementation involves changing two camera view parameters when generating a projection of an image such as a light-field image: the camera location and the camera tilt. Conceptually, such adjustments can be visualized by imagining a camera with a string attached to the center of the scene. The string forces the camera to always point towards the center of the scene as well maintain a constant distance from the center. The length of the string can be changed, to vary the ratio of tilt to location.

Depth information used for implementing the parallax shift can be acquired by any suitable means. In at least one embodiment, image 101 is a light-field image that encodes depth information. In another embodiment, image 101 can be a computer-generated image for which depth information has been derived or generated. Alternatively, any other suitable technique, such as stereoscopic capture method and/or scene analysis, can be applied.

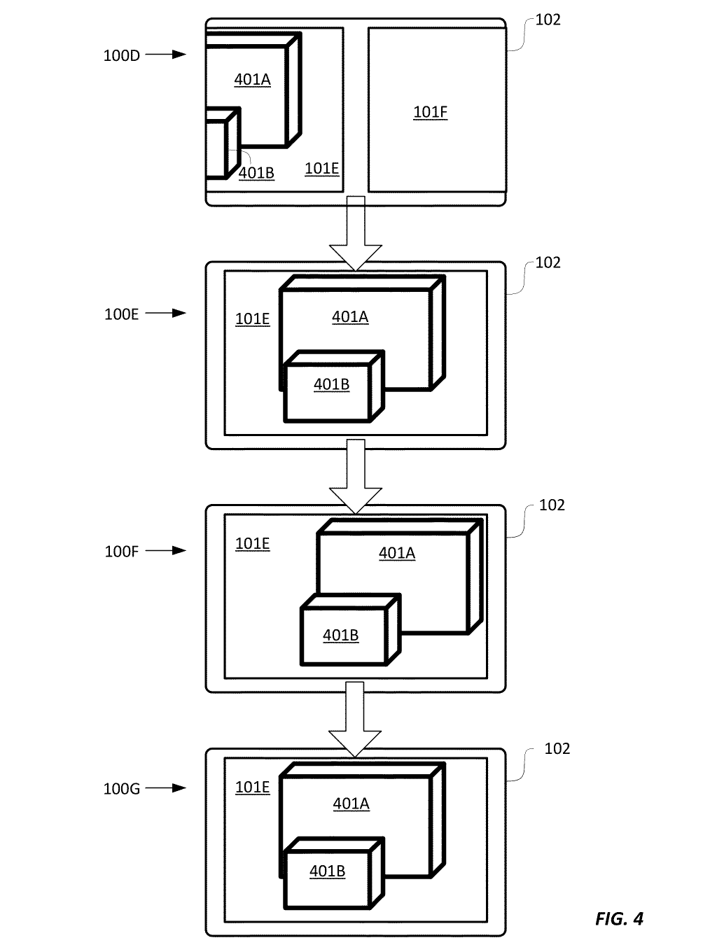

Referring now to FIG. 4, there is shown an example illustrating application of a parallax bounce effect to an image 101 displayed on display screen 102 of an electronic device (such as device 201), according to one embodiment. In this example, image 101 includes two objects: foreground object 401B and background object 401A. Background object 401A is located farther away from the camera viewpoint (or viewer) than foreground object 401B; thus, object 401A is said to have a higher lambda value (or greater depth) than object 401B. The example shown in FIG. 4 represents a parallax bounce that might be applied, for example, after image 101 has slid into position from left to right.

In screen shot 100D, image 101E is in the process of being slid from left to right, for example in response to a scroll command entered by the user in the form of a left-to-right swipe gesture. Previously displayed image 101F slides off the right edge of display screen 102 as image 101E slides in from the left edge.

Screen shot 100E depicts image 101E just after the scroll operation has taken place; image 101E is now at (or near) its target position on display screen 102. In at least one embodiment, the parallax bounce effect can be initiated just after the slide is complete, or just before the slide is complete, for example as image 101E is still in motion as part of the slide animation.

In screen shot 100F, the parallax bounce has reached its most displaced point. Both objects 401B are shifted to the right, to simulate a change in viewpoint to the right. Relative depth is emphasized by shifting object 401A (having greater depth) more than object 401B. This produces a parallax effect, wherein object 401B can be seen to move laterally with respect to object 401A behind it, simulating actual parallax in the real world.

In screen shot 100G, the parallax bounce is complete, and image 101E returns to its previous state. The apparent viewpoint, having momentarily shifted to the right, shifts back to where it was. In at least one embodiment, such shifts in viewpoint (and the attendant movement of objects 401A, 401B) are performed in a progressive, continuous manner, without any sudden or discontinuous transitions. The viewpoint shifts can be performed using a predefined curve, as described in more detail below. In this manner, the described method reinforces the notion that objects 401A, 401B in image 101E have different depths and move in relation to one another in a realistic way.

As mentioned above, the example shown in FIG. 4 represents a parallax bounce that might be applied, for example, after image 101E has slid into position from left to right. If image 101E slides in from another direction (e.g. from right to left, or vertically, or diagonally), a parallax bounce in a corresponding direction can be applied; thus, in at least one embodiment, the direction of the parallax bounce is parallel to the direction in which image 101E slid into position. In other embodiments, the parallax bounce can be in any arbitrary direction, and need not be parallel to the direction in which image 101E slid into position.

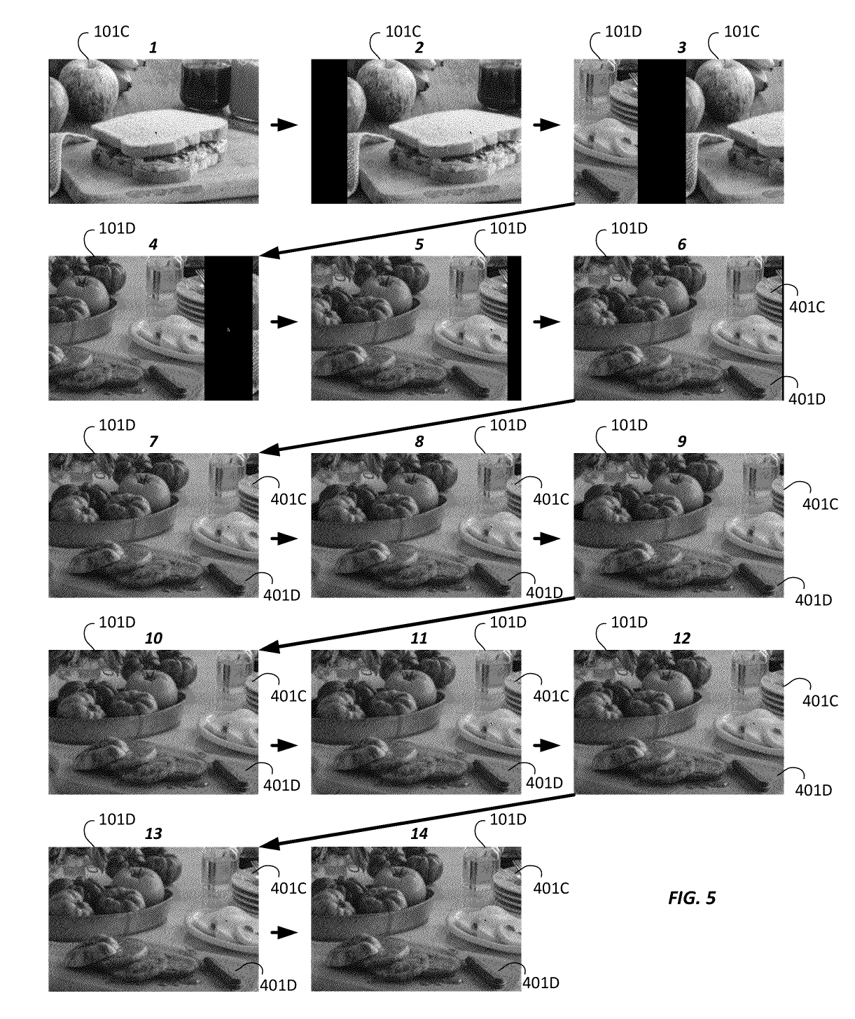

Referring now to FIG. 5, there is shown another example illustrating application of a parallax bounce effect to an image 101D displayed on display screen 102 of an electronic device (such as device 201), according to one embodiment. The fourteen screen shots shown in FIG. 5 (numbered 1 through 14) depict a transition from image 101C to image 101D, wherein the following take place:
image 101C slides off the screen and image 101D takes its place, using a left-to-right sliding motion (screen shots 1 through 6);
a parallax bounce effect is applied to image 101D, progressively increasing in magnitude from screen shots 7 through 10 (bounce-out); and
the parallax bounce effect is reversed, progressively decreasing in magnitude from screen shots 11 through 14 (bounce-back).

As can be seen, the application of the parallax bounce effect is continuous. The parallax bounce is applied by changing the apparent viewpoint from which the scene is viewed; this causes objects in image 101D to shift from left to right. Objects having greater depth (i.e., farther from the viewer), such as plates 401C, are shifted more than objects having lesser depth (i.e., closer to the viewer), such as knife 401D.

In this example, once the parallax bounce effect has been applied and reversed, the image is back at its starting point; screen shot 14 is virtually identical to screen shot 6.

Although the above description sets forth the parallax bounce technique in the context of an image that is being slid into place by a scroll command, the parallax bounce effect can be used in any situation where an image's location changes over time, which can be triggered either automatically or manually by a user. Examples include scrolling (horizontal or vertical), page scrolling (one “page” at a time), or any technique where an image moves from one location to another. In addition, the effect is not limited to linear movements along a horizontal or vertical axis. A user may for example, “pick up” an image and freely move it about on a display screen; as the user goes from a rapid change to a slower or stopped one, a parallax bounce may be initiated to give a sense of weight and inertia to the image.

One skilled in the art will recognize that the examples depicted and described herein are merely illustrative, and that other arrangements of user interface elements can be used. In addition, some of the depicted elements can be omitted or changed, and additional elements depicted, without departing from the essential characteristics.

The present system and method have been described in particular detail with respect to possible embodiments. Those of skill in the art will appreciate that the system and method may be practiced in other embodiments. First, the particular naming of the components, capitalization of terms, the attributes, data structures, or any other programming or structural aspect is not mandatory or significant, and the mechanisms and/or features may have different names, formats, or protocols. Further, the system may be implemented via a combination of hardware and software, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrases “in one embodiment” or “in at least one embodiment” in various places in the specification are not necessarily all referring to the same embodiment.

Various embodiments may include any number of systems and/or methods for performing the above-described techniques, either singly or in any combination. Another embodiment includes a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions can be embodied in software, firmware and/or hardware, and when embodied in software, can be downloaded to reside on and be operated from different platforms used by a variety of operating systems.

The present document also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, DVD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the system and method are not described with reference to any particular programming language. It will be appreciated that a variety of programming languages may be used to implement the teachings described herein, and any references above to specific languages are provided for disclosure of enablement and best mode.

Accordingly, various embodiments include software, hardware, and/or other elements for controlling a computer system, computing device, or other electronic device, or any combination or plurality thereof. Such an electronic device can include, for example, a processor, an input device (such as a keyboard, mouse, touchpad, track pad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the described system and method include: a mobile phone, personal digital assistant, smartphone, kiosk, server computer, enterprise computing device, desktop computer, laptop computer, tablet computer, consumer electronic device, or the like. An electronic device may use any operating system such as, for example and without limitation: Linux; Microsoft Windows, available from Microsoft Corporation of Redmond, Wash.; Mac OS X, available from Apple Inc. of Cupertino, Calif.; iOS, available from Apple Inc. of Cupertino, Calif.; Android, available from Google, Inc. of Mountain View, Calif.; and/or any other operating system that is adapted for use on the device.

While a limited number of embodiments have been described herein, those skilled in the art, having benefit of the above description, will appreciate that other embodiments may be devised. In addition, it should be noted that the language used in the specification has been principally selected for readability and instructional purposes, and may not have been selected to delineate or circumscribe the subject matter. Accordingly, the disclosure is intended to be illustrative, but not limiting, of scope.

What is claimed is:

1. A method for applying a parallax bounce effect to a display of an image on an electronic display screen, comprising:
on the display screen, moving an image from a first location to a second location;
applying a progressively increasing parallax shift to the image until a maximum parallax shift is reached; and
progressively reducing the parallax shift to the image until a minimum parallax shift is reached.

2. The method of claim 1, wherein:
applying the progressively increasing parallax shift comprises increasing the parallax shift in a continuous manner; and
progressively reducing the parallax shift comprises decreasing the parallax shift in a continuous manner.

3. The method of claim 1, wherein:
applying the progressively increasing parallax shift comprises increasing the parallax shift according to a first timing curve; and
progressively reducing the parallax shift comprises decreasing the parallax shift according to a second timing curve.

4. The method of claim 1, wherein the minimum parallax shift is zero.

5. The method of claim 1, further comprising, prior to applying the progressively increasing parallax shift, determining a maximum parallax shift based on a measurement of speed with which the image moves from the first location to the second location.

6. The method of claim 5, wherein the maximum parallax shift is based the average speed of the image as it moves from the first location to the second location.

7. The method of claim 1, wherein moving an image from a first location to a second location comprises sliding the image along an axis;
and wherein applying the progressively increasing parallax shift to the image comprises applying the progressively increasing parallax shift in a direction parallel to the axis.

8. The method of claim 7, wherein the axis comprises a horizontal axis.

9. The method of claim 7, wherein the axis comprises a vertical axis.

10. The method of claim 1, further comprising:
at an input device, receiving using input to move the image from the first location to the second location;
and wherein moving the image is performed responsive to the received user input.

11. The method of claim 1, further comprising:
at an input device, receiving using input to scroll through a sequence of images including the image;
and wherein moving the image is performed responsive to the received user input.

12. The method of claim 1, wherein applying the progressively increasing parallax shift to the image is performed subsequent to the image reaching the second location.

13. The method of claim 1, wherein applying the progressively increasing parallax shift to the image is performed before the image has reached the second location.

14. The method of claim 1, wherein applying the progressively increasing parallax shift comprises progressively changing an apparent viewpoint for the image.

15. The method of claim 1, wherein the image comprises a projection of a light-field image, and wherein applying the progressively increasing parallax shift comprises progressively changing an apparent viewpoint for the projection of the light-field image.

16. The method of claim 1, further comprising causing the image to stop moving as it reaches the second location.

17. The method of claim 1, further comprising causing the image to decelerate as it approaches the second location.

18. A non-transitory computer-readable medium for applying a parallax bounce effect to a display of an image on an electronic display screen, comprising instructions stored thereon, that when executed on a processor, perform the steps of:
causing the display screen to move an image from a first location to a second location;
applying a progressively increasing parallax shift to the image until a maximum parallax shift is reached; and
progressively reducing the parallax shift to the image until a minimum parallax shift is reached.

19. The non-transitory computer-readable medium of claim 18, wherein:
applying the progressively increasing parallax shift comprises increasing the parallax shift in a continuous manner; and
progressively reducing the parallax shift comprises decreasing the parallax shift in a continuous manner.

20. The non-transitory computer-readable medium of claim 18, wherein:
applying the progressively increasing parallax shift comprises increasing the parallax shift according to a first timing curve; and
progressively reducing the parallax shift comprises decreasing the parallax shift according to a second timing curve.

21. The non-transitory computer-readable medium of claim 18, further comprising instructions stored thereon, that when executed on a processor, perform the step of, prior to applying the progressively increasing parallax shift, determining a maximum parallax shift based on a measurement of speed with which the image moves from the first location to the second location.

22. The non-transitory computer-readable medium of claim 21, wherein the maximum parallax shift is based the average speed of the image as it moves from the first location to the second location.

23. The non-transitory computer-readable medium of claim 18, wherein moving an image from a first location to a second location comprises sliding the image along an axis;
and wherein applying the progressively increasing parallax shift to the image comprises applying the progressively increasing parallax shift in a direction parallel to the axis.

24. The non-transitory computer-readable medium of claim 18, further comprising instructions stored thereon, that when executed on a processor, perform the step of:
at an input device, receiving using input to move the image from the first location to the second location;
and wherein moving the image is performed responsive to the received user input.

25. The non-transitory computer-readable medium of claim 18, further comprising instructions stored thereon, that when executed on a processor, perform the step of:
at an input device, receiving using input to scroll through a sequence of images including the image;
and wherein moving the image is performed responsive to the received user input.

26. The non-transitory computer-readable medium of claim 18, wherein applying the progressively increasing parallax shift to the image is performed subsequent to the image reaching the second location.

27. The non-transitory computer-readable medium of claim 18, wherein applying the progressively increasing parallax shift to the image is performed before the image has reached the second location.

28. The non-transitory computer-readable medium of claim 18, wherein applying the progressively increasing parallax shift comprises progressively changing an apparent viewpoint for the image.

29. The non-transitory computer-readable medium of claim 18, wherein the image comprises a projection of a light-field image, and wherein applying the progressively increasing parallax shift comprises progressively changing an apparent viewpoint for the projection of the light-field image.

30. The non-transitory computer-readable medium of claim 18, further comprising instructions stored thereon, that when executed on a processor, perform the step of causing the image to stop moving as it reaches the second location.

31. The non-transitory computer-readable medium of claim 18, further comprising instructions stored thereon, that when executed on a processor, perform the step of causing the image to decelerate as it approaches the second location.

32. A system for applying a parallax bounce effect to a display of an image on an electronic display screen, comprising:
a display screen, configured to display an image moving from a first location to a second location;
a processor, communicatively coupled to the display screen, configured to cause the display screen to:
apply a progressively increasing parallax shift to the image until a maximum parallax shift is reached; and
progressively reduce the parallax shift to the image until a minimum parallax shift is reached.

33. The system of claim 32, wherein:
the processor is configured to cause the display screen to apply the progressively increasing parallax shift by increasing the parallax shift in a continuous manner; and
the processor is configured to cause the display screen to progressively reduce the parallax shift by decreasing the parallax shift in a continuous manner.

34. The system of claim 32, wherein:
the processor is configured to cause the display screen to apply the progressively increasing parallax shift by increasing the parallax shift according to a first timing curve; and
the processor is configured to cause the display screen to progressively reduce the parallax shift by decreasing the parallax shift according to a second timing curve.

35. The system of claim 32, wherein the processor is further configured to, prior to applying the progressively increasing parallax shift, determine a maximum parallax shift based on a measurement of speed with which the image moves from the first location to the second location.

36. The system of claim 35, wherein the maximum parallax shift is based the average speed of the image as it moves from the first location to the second location.

37. The system of claim 32, wherein the display screen is configured to slide the image along an axis;
and wherein the processor is configured to cause the display screen to apply the progressively increasing parallax shift to the image by applying the progressively increasing parallax shift in a direction parallel to the axis.

38. The system of claim 32, further comprising:
an input device, communicatively coupled to the processor, configured to receive using input to move the image from the first location to the second location;
and wherein the processor is configured to cause the display screen to move the image responsive to the received user input.

39. The system of claim 32, further comprising:
an input device, communicatively coupled to the processor, configured to receive using input to scroll through a sequence of images including the image;
and wherein the processor is configured to cause the display screen to move the image responsive to the received user input.

40. The system of claim 32, wherein the processor is configured to cause the display screen to apply the progressively increasing parallax shift to the image subsequent to the image reaching the second location.

41. The system of claim 32, wherein the processor is configured to cause the display screen to apply the progressively increasing parallax shift to the image before the image has reached the second location.

42. The system of claim 32, wherein the processor is configured to cause the display screen to apply the progressively increasing parallax shift by progressively changing an apparent viewpoint for the image.

43. The system of claim 32, wherein the image comprises a projection of a light-field image, and wherein the processor is configured to cause the display screen to apply the progressively increasing parallax shift by progressively changing an apparent viewpoint for the projection of the light-field image.

44. The system of claim 32, wherein the processor is configured to cause the display screen to stop moving as it reaches the second location.

45. The system of claim 32, wherein the processor is configured to cause the display screen to decelerate as it approaches the second location.
